(19) United States
(12) Patent Application Publication
(10) Pub. No.: US 2002/0077928 A1
(43) Pub. Date: Jun. 20, 2002

(54) Online method and apparatus for delivering home repair information to a subscriber

(76) Inventor: James D. O'Brien, Coatsville, PA (US)

Correspondence Address: Daniel H. Golub, MORGAN, LEWIS & BOCKIUS LLP, 1701 Market Street, Philadelphia, PA, 19103-2921, US

(21) Appl. No.: 09/765,961

(22) Filed: Jan. 20, 2001

Related U.S. Application Data
(60) Provisional application No. 60/177,289, filed on Jan. 21, 2000.

(51) Int. Cl. G06F 17/60

(52) U.S. Cl. 705/26

(57) ABSTRACT

A method for delivering home repair information to a home owner over a global computer network, such as the internet. The home owner is presented with a first internet web page that contains a first list of home repair topics. In response to selection by the home owner of a home repair topic from the first internet web page, a second internet web page that contains a second list of home repair topics is presented to the user. The second set of home repair topics on the second web page correspond to specific home repair topics associated with the home repair topic selected from the first web page. In response to the selection by the home owner of a home repair topic from the second internet web page, a full-length video segment is downloaded to a computer associated with the home owner. The full-length video segment preferably includes step-by-step instructions as to how to complete a project associated with the home repair topic selected from the second web page.

### CROSS-REFERENCE TO RELATED APPLICATION

The present application claims priority based on provisional application No. 60/177,289, filed Jan. 21, 2000, entitled “Home Repair Information System.”

### BACKGROUND

Individual home owners often desire to perform home repairs themselves, without having to hire a professional. Obviously, if an individual homeowner is able to successfully complete such a repair, without the involvement a professional, the homeowner can achieve a substantial financial savings.

At present, there are numerous nationwide retail chains that cater to the individual homeowner that wishes to repair or improve their home. These retail chains typically supply home owners with materials and tools that can be used in completing home repairs. However, these retail chains are, at present, unable to provide the homeowner with substantial guidance on how to complete the repair once the homeowner leaves the store. These retail chains are limited to providing guidance to customers by means of store sales people, who often have only limited time and/or experience upon which to explain home repair procedures to the home owner.

The retail chains often typically carry books/videos and/or give seminars for completing home repairs. The books/videos suffer from several drawbacks. First, a home owner must actually go to the store to purchase the book/video. To the extent that a homeowner needs to complete a repair and the home owner is unable to get access to the store because, for example, the store is closed, the home owner must wait in order to move forward with the home repair. In some situations such as, for example, emergency home repair situations, the delay caused by such waiting may be unacceptable and may result in the home owner having to contact a professional to complete the repair. The books/videos available at the retail chains also suffer from the drawback that they are not interactive. Thus, if the home owner purchases a book/video for completing a home repair and, when the home owner arrives home and begins the home repair project, the home owner discovers that further information not included in the book/video is required to complete the repair, the home owner must stop the repair, return to the store and attempt to find a further book/video in order to complete the repair. Having to constantly return to the store for further information in order to complete a repair has obvious drawbacks in terms of convenience to the home owner.

Although home owners desire to perform home repairs themselves, there are other home owners that either do not have the time or desire to complete such repairs on their own. These home owners must work with an outside contractor to have their repairs completed. Unfortunately, many homeowners have a distrust for contractors, because the home owners have no way of monitoring whether the contractor is performing the repair properly and/or at a reasonable price.

It is an object of the present invention to provide an on-line system for delivering home repair information to a home owner that can be accessed at anytime, 24 hours a day.

It is a further object of the present invention to provide an on-line system for delivering home repair information in an interactive format that allows a home owner to preview home repair information and to select and retrieve further home repair information on-line in real time if it turns out that such additional information is needed by the home owner to complete the repair.

It is a further object of the present invention to provide a home owner with the necessary information needed to monitor the performance of a home repair contractor in order to assure that the contractor is performing a repair properly and at a reasonable price.

These and other objects of the present invention will become apparent from the description that follows.

### SUMMARY OF THE INVENTION

The present invention is directed to a method for delivering home repair information to a home owner over a global computer network, such as the Internet. The home owner is presented with a first internet web page that contains a first list of home repair topics. In response to selection by the home owner of a home repair topic from the first internet web page, a second Internet web page that contains a second list of home repair topics is presented to the user. The second set of home repair topics on the second web page correspond to specific home repair topics associated with the home repair topic selected from the first web page. In response to the selection by the home owner of a home repair topic from the second internet web page, a full-length video segment is downloaded to a computer associated with the home owner. The full-length video segment preferably includes step-by-step instructions as to how to complete a project associated with the home repair topic selected from the second web page.

In accordance with a preferred embodiment, in response to the selection by the home owner of a home repair topic from the second internet web page, the home owner's computer is provided with a preview video segment. The preview video segment preferably includes an overview of a project associated with the home repair topic selected from the second web page, and some general introductory information about the full-length video segment discussed above. After the user views the preview video segment, the full-length video segment is downloaded to the computer associated with the home owner if the home owner approves of such downloading after viewing of the preview. In one embodiment, the preview segment is provided to the home owner at no charge, and the home owner is required to pay a subscription or downloading charge if the user opts to download the full-length video segment. The home owner preferably makes this payment on-line by entering credit card information onto a web page after viewing of the preview segment has been completed.

In accordance with a further aspect of the invention, following the selection by the home owner of a home repair topic from the second internet web page, a third internet web page is presented to the user that contains a list of materials required to complete the home repair topic selected from the second internet web page. The list of materials includes a quantity and a price associated with each item on the list of materials. The information required to present the list of materials is stored and retrieved from a database associated with the home repair web site. The list of materials may be presented either before or after the full-length video is downloaded to the home owner's computer.

In a particularly preferred embodiment, the home owner is initially prompted to enter a zip code associated with a geographic location of the home owner when the home owner first logs onto the home repair web site. In response to the zip code and the home repair topic selected from the second internet web page, the home owner is presented (via a further web page or a printout) with a list of suppliers in the geographic location of the home owner that can supply the home owner with each of the items on the list of materials required to complete the home repair topic selected from the second internet web page. The list of suppliers is stored and retrieved from a database associated with the home repair web site, and may be presented either before or after the full-length video is downloaded to the home owner's computer.

In accordance with a still further aspect, in response to the zip code and the home repair topic selected from the second internet web page, a list of contractors in the geographic location of the home owner that can complete a home repair project associated with the home repair topic selected from the second Internet web page is presented to the user. The list of contractors is stored and retrieved from a database associated with the home repair web site, and may be presented either before or after the full-length video is downloaded to the home owner's computer. With the list of materials (including price and quantity) of materials required to complete the subject project, as well as the full-length video detailing step-by-step how the project should properly be completed, the home owner not interested in completing the project him/herself can contact a contractor from the list and, with such information, have all that is required to assure that the contractor is both charging a fair price for the home repair and completing the home repair properly. The home owner can be certain that the price is fair because the home owner will know what the materials for the project cost, and will only have to assess the reasonableness of the labor portion of any price estimate from the contractor. In addition, since the home owner has the step-by-step video showing how the project should properly be completed, the home owner can monitor the contract to make sure that the contractor is performing the job properly and not cutting any corners.

In a preferred implementation, all of the web pages referred to above are implemented on a single site that is serviced using a single web server having an associated database. It will be understood by those skilled in the art, however, that the method of the present invention may be implemented using multiple web sites.

The principles of the present invention may be readily extended to other repair areas beyond home repairs such as, for example, auto repairs. In addition, the principles of the present invention may be extended to non-repair fields, such as the delivery of recipe information for completing cooking procedures.

### BRIEF DESCRIPTION OF THE DRAWINGS

The features, objects, and advantages of the present invention will become more apparent from the detailed description set forth below when taken in conjunction with the drawings.

FIG. 1 shows a first web page for implementing an on-line home repair information system, in accordance with the present invention.

FIG. 2 shows a second web page for implementing an on-line home repair information system, in accordance with the present invention.

FIG. 3 shows a further web page for implementing an on-line home repair information system, in accordance with the present invention.

FIG. 4 shows a web page for previewing video information relating to a selected home repair topic, in accordance with the present invention.

FIG. 5 shows a web page for presenting guidelines for downloading video information to the user, in accordance with the present invention.

FIG. 6 shows a web page for presenting warranty/copyright information to the user and collecting payment information from the user, in accordance with the present invention.

FIG. 7 shows a web page for presenting reminders to the user to assist in downloading information to the user, in accordance with the present invention.

FIG. 8 shows a list of materials associated with a selected home repair topic, in accordance with the present invention.

FIG. 9 shows a list of contractors associated with a selected home repair topic, in accordance with the present invention.

### DETAILED DESCRIPTION OF THE INVENTION

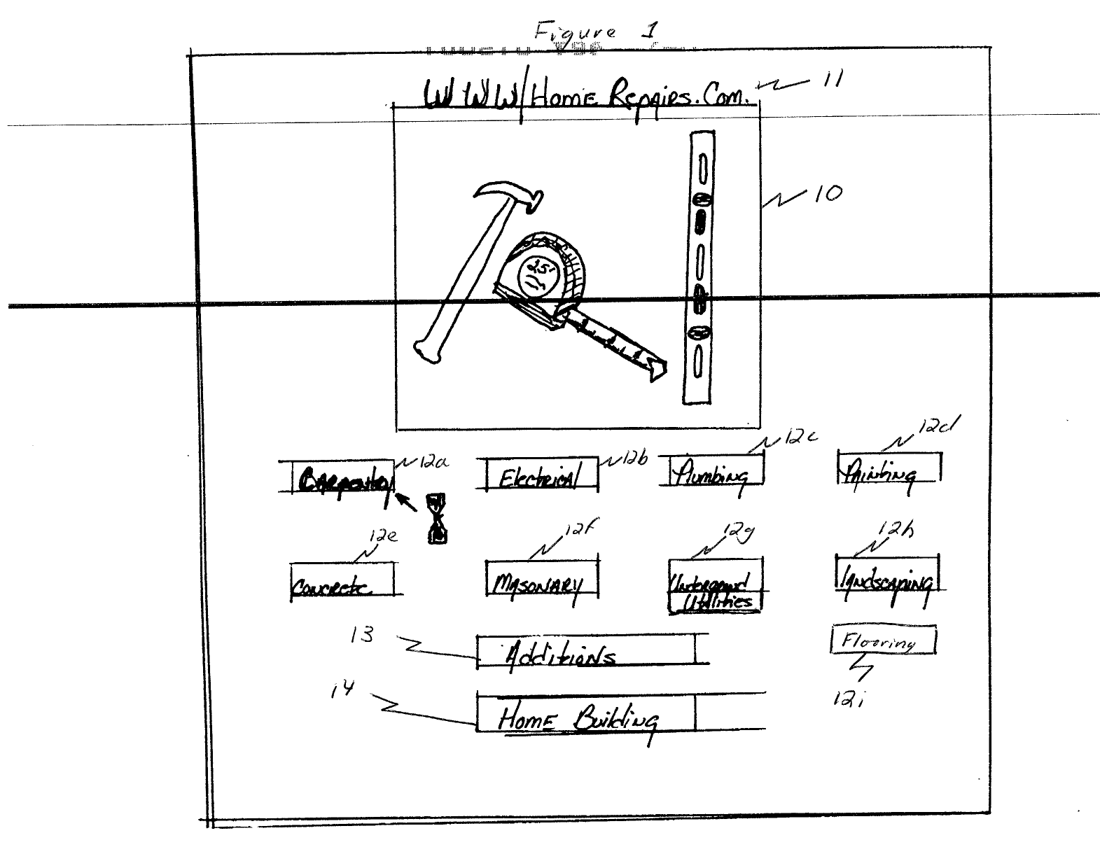

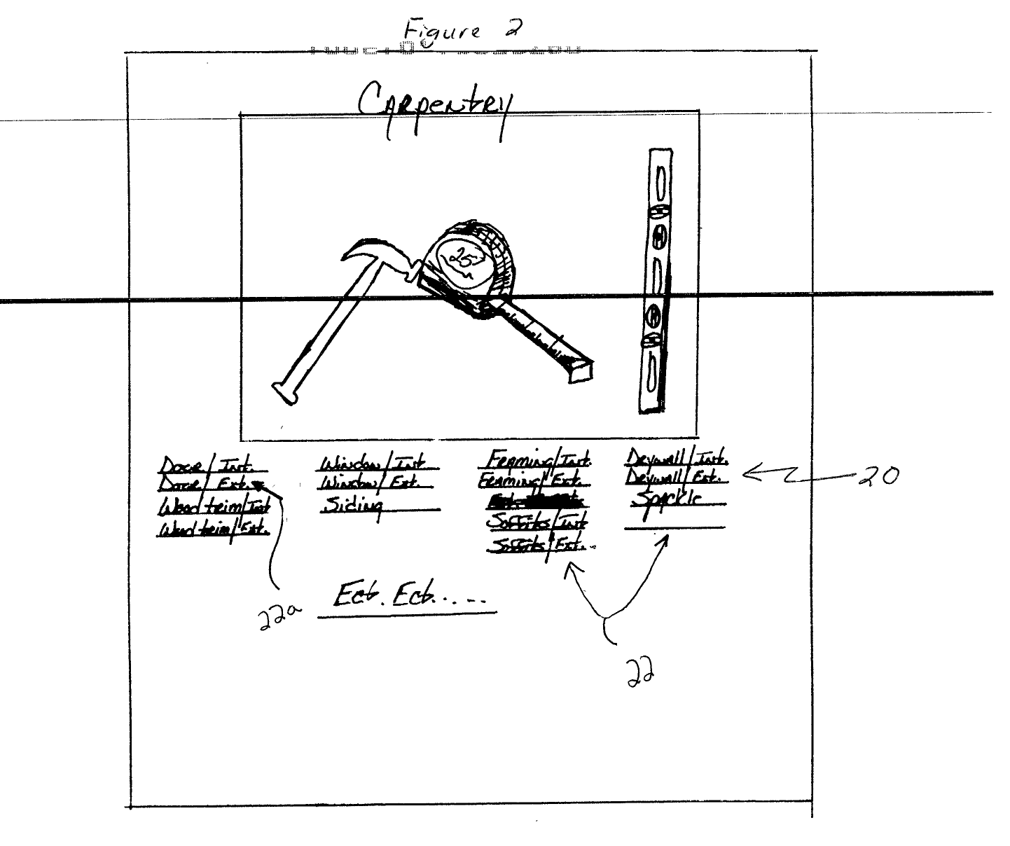

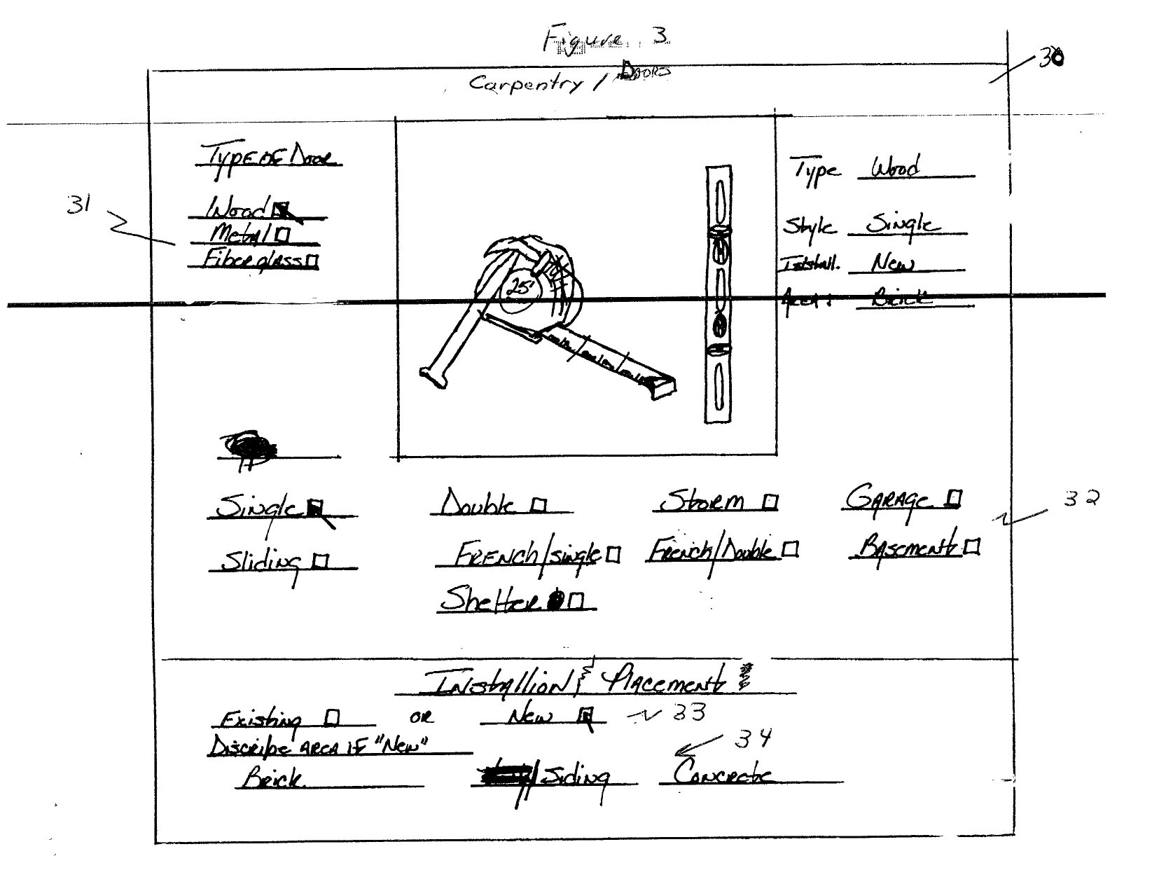

The present invention allows the common man or women, who generally would not attempt something like home repair, the ability to try to do their own home repair project themselves, by way of logging on to a web site that has interactive capabilities, and for that person to pick the topic (from a wide range of categories) that best matches their particular home project. Referring now to FIG. 1, once the user has logged onto the web site, a first web page 11 appears, and on page 11 there may optionally be a picture 10 (generally relating to home repair) followed by or combined on the same page, with a list of categories or topics, such as home repair topics 12a, 12b, 12c, 12d, 12e, 12f, 12g, 12h, 13 and 14. In response to a selection by the user of a home repair topic from the first page 11, a second web page 20 that contains a second list of home repair topics 22 is presented to the user. The second set of home repair topics 22 on the second web page 20 correspond to specific home repair topics associated with the home repair topic selected by the user from the first web page 11. Thus, for example, the home specific home repair topics 22 on FIG. 2 (which relate to carpentry) would appear in response to the selection by the user of topic 12a from page 11. On second page 20, several more specific topics are thus displayed. Optionally, the user can continue to drill down to still more specific topics using one or more further web pages (such as web page 30 shown in FIG. 3) until the user has reached the most exact or closest description that best matches the home project sought to be completed by the user. Alternatively, the system can be designed so that the most specific topics are presented on the second page 20, rather than on some later page.

Referring again to FIG. 3, if, for example, the user selected “doors” (22a) as a topic from web page 20, a third web page 30 that related only to doors may be presented to the user to still further define the home repair project sought to be completed by the user. In particular, by clicking on the boxes defining door type 31, style 32, installation 33 and area 34 in which the door will be placed, the user can still further define the home repair project to be completed.

The object of pages 11, 20 and 30 is to narrow down to the closest detail the project that user would like to attempt. It will be understood by those skilled in the art that, although in the described embodiment, three web pages are used to accomplish the narrowing down of the topics, this narrowing down process could be accomplished using only two web pages or alternatively, by using four or more web pages.

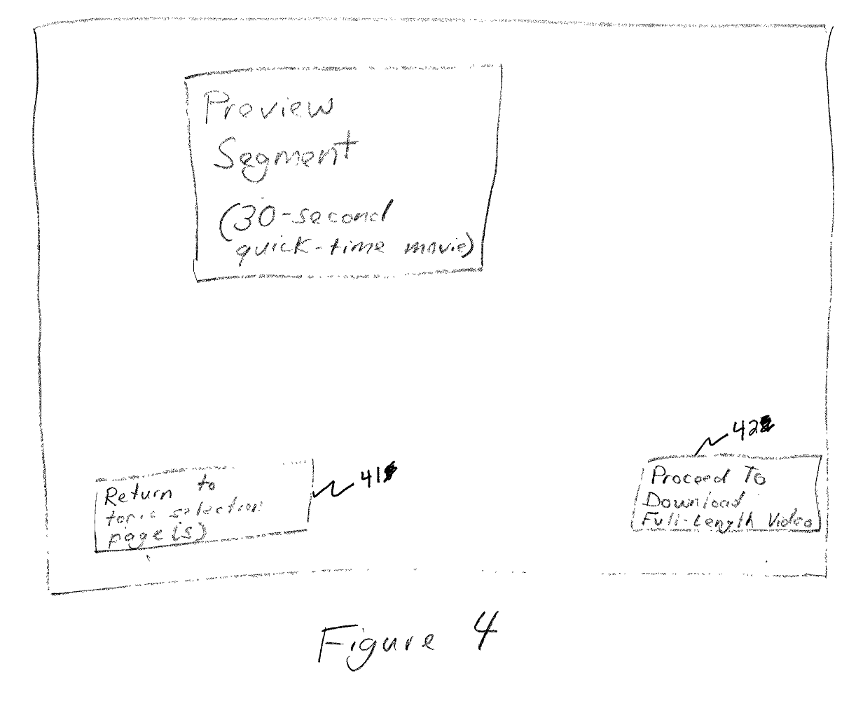

After identifying the specific home repair topic that relates to the project that the user seeks to complete, the user then preferably clicks “continue” (not shown), and a 30 second to 60 second video clip associated with the selected project is presented to the user. The video clip may be shown, for example, as part of web page 40 shown in FIG. 4. The video clip may optionally be presented with music only (i.e., no words.) The video clip does two things. First, the video clip allows the user to verify if the specific topic identified by the user (using, for example, pages 11, 20 and 30) represents the information that the user seeks. If not, the user can click back to previous pages 11, 20 and 30 (using button 41) and repeat the topic selection process described above. Second, if the video clip represents the information that the user is in fact seeking and the user is interested in seeing the entire visual video package and services related to the selected topic, the user can click on button 42 and thereafter begin taking steps to down load a full length video segment and receive services that correspond to previously viewed video clip.

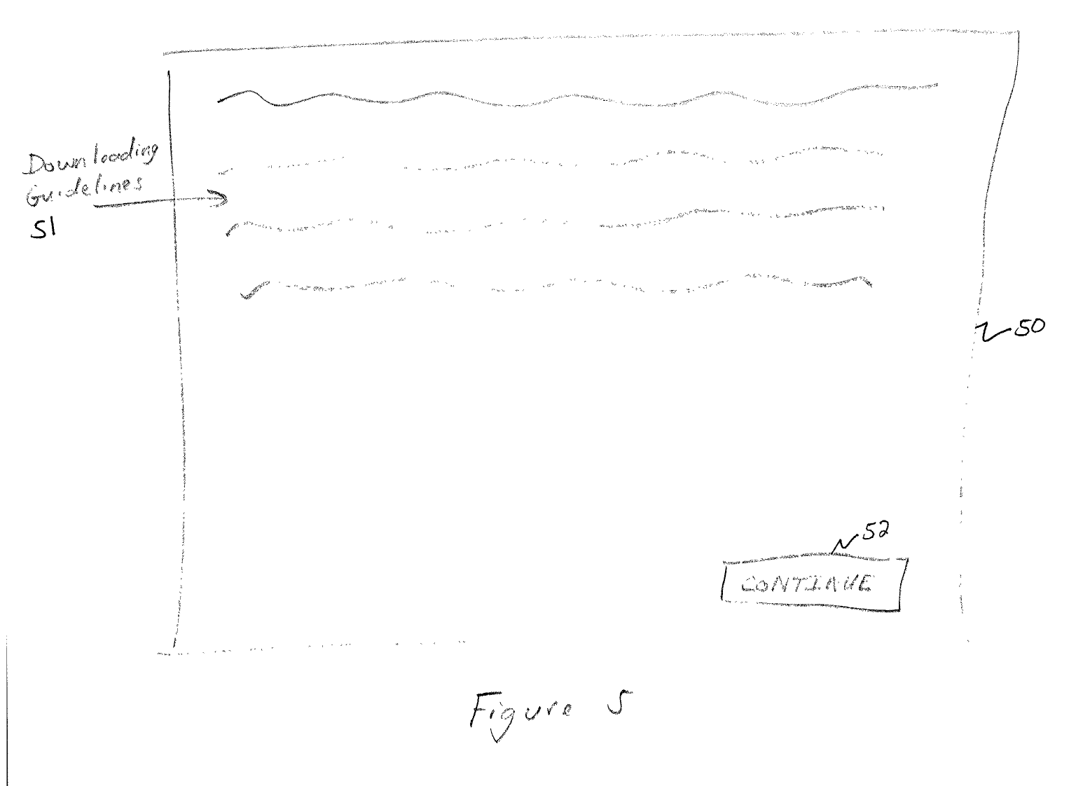

If the user clicks on button 42, web page 50 (FIG. 5) is next presented to the user. Web page 50 presents downloading guidelines 51 to the user. Guidelines 51 may include, for example:

1) the fee or cost to the individual for down loading the selected information, e.g. a flat fee;

2) a list of what the user will be receiving from this service. For example, in one embodiment, the user will receive:

a) a video or DVD - a visual guide describing with video and audio step-by-step instruction for completing the selected home repair project;

b) a printout displaying:

1) step-by-step instructions for completing the selected home repair project;

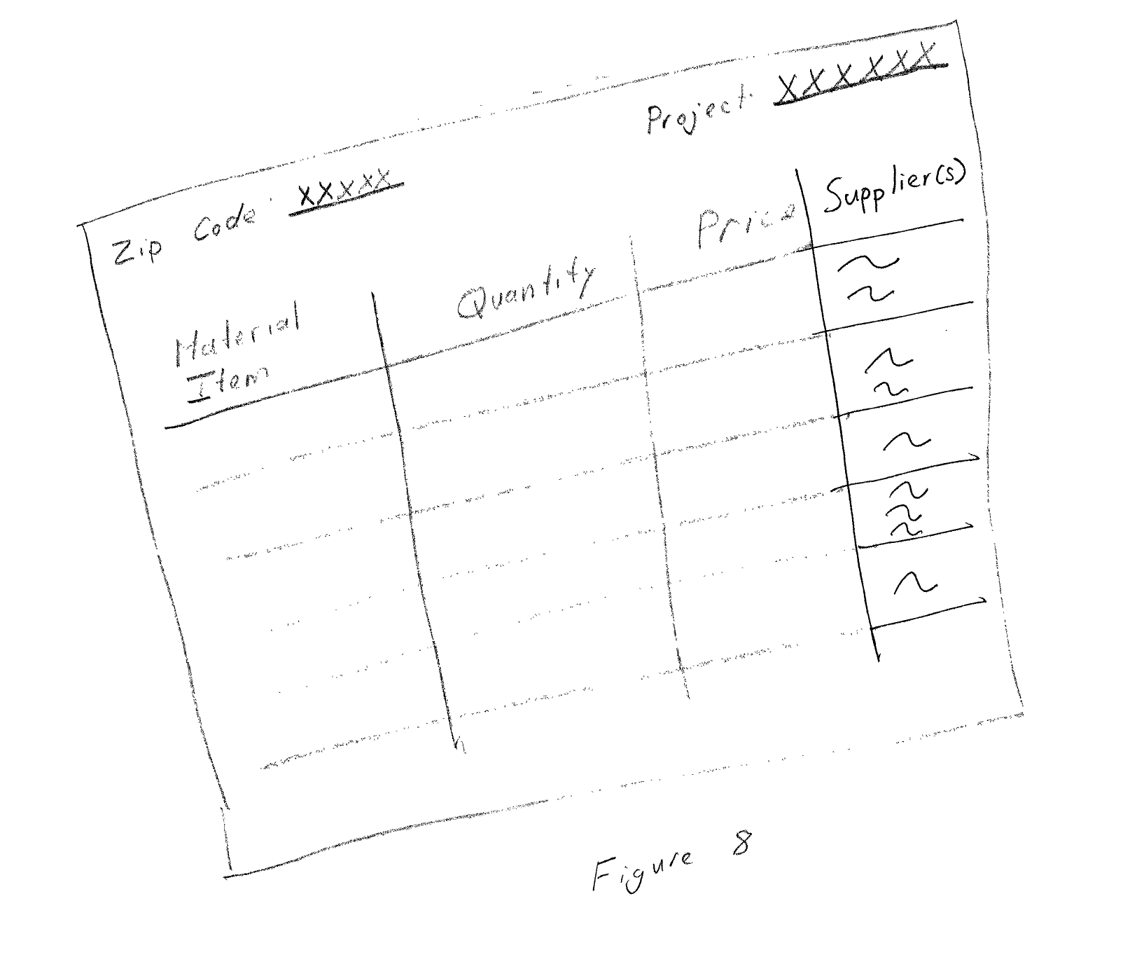

2) material quantities for completing the selected home repair project (shown in FIG. 8);

3) a project cost analysis for completing the selected home repair project;

4) a list of distributors that supply the materials necessary for completing the selected home repair project (also shown as part of FIG. 8); and

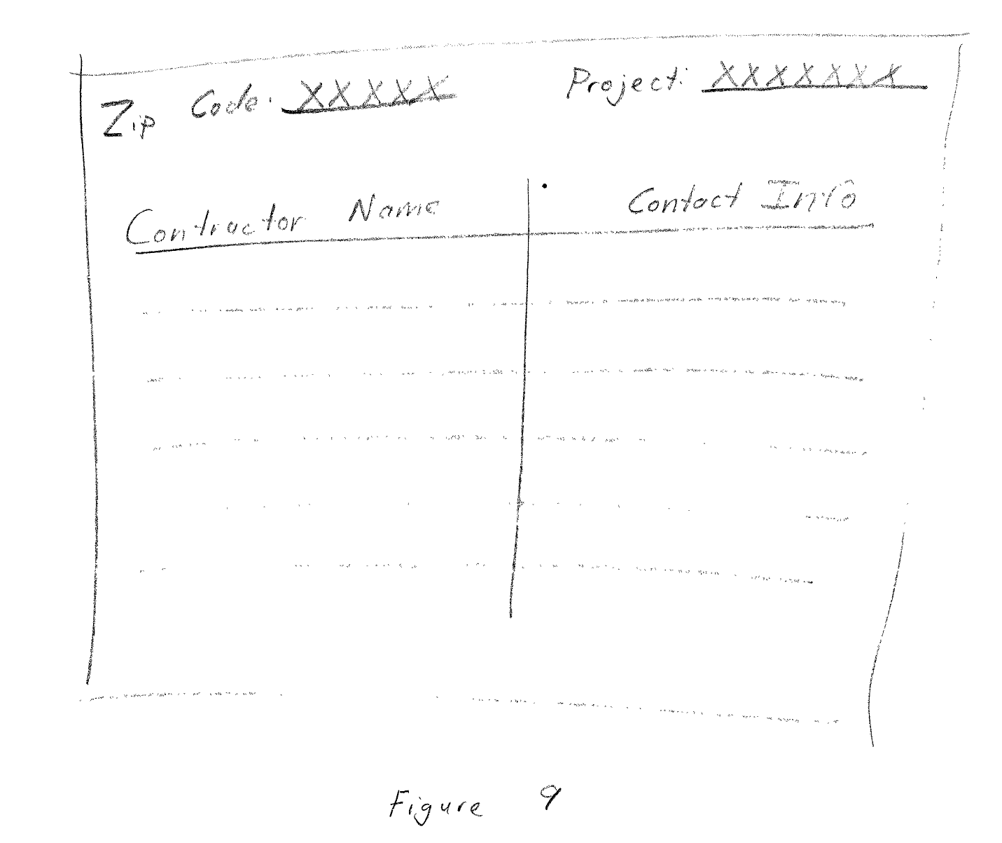

5) a list of contractors that the user can use to complete the selected home repair project if, for example the user does not want to complete the project themselves of if the user runs into completion problems (shown in FIG. 9).

After the user reads guidelines 51, the user can continue the process of downloading (or retrieving) the information identified in the guidelines 51 by clicking “continue” button 52.

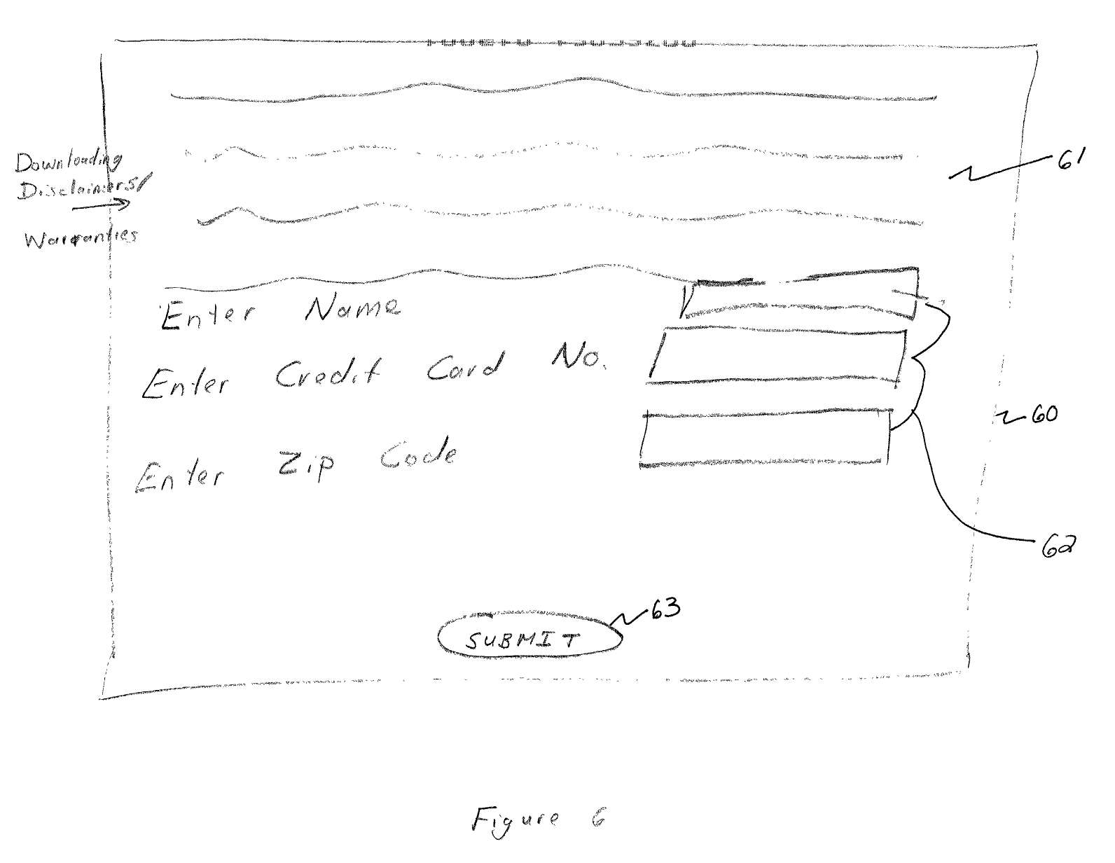

In response to the “clicking” of button 52, a further web page 60 (FIG. 6) is next presented to the user. Web page 60 presents warranty/copyright information 61 relating to the information/video identified in guidelines 51 to the user and is used to collect payment information 62 from the user. The copyright information includes, for example, information identifying any applicable copyrights associated with the information/video to be delivered to the user. The warranty information indicates, for example, that attempting to install something by following a downloaded video does not necessarily mean that the video will include the information that the user desires or that the video will necessarily cover every situation that they may encounter if they take on their particular project. Information 61 also preferably includes a statement indicating that a list of local contractors specializing in a field associated with the selected project will be provided for the user to contact, if desired. After reading through information 61, the user may continue by entering payment information 62 into web page 60. Such information includes entry by the user of their:

1) name;

2) zip code or area code; and

3) credit card information. Once the payment information 62 has been entered and verified by the user, the user can continue to proceed to receive the desired information by “clicking” on “submit” button 63.

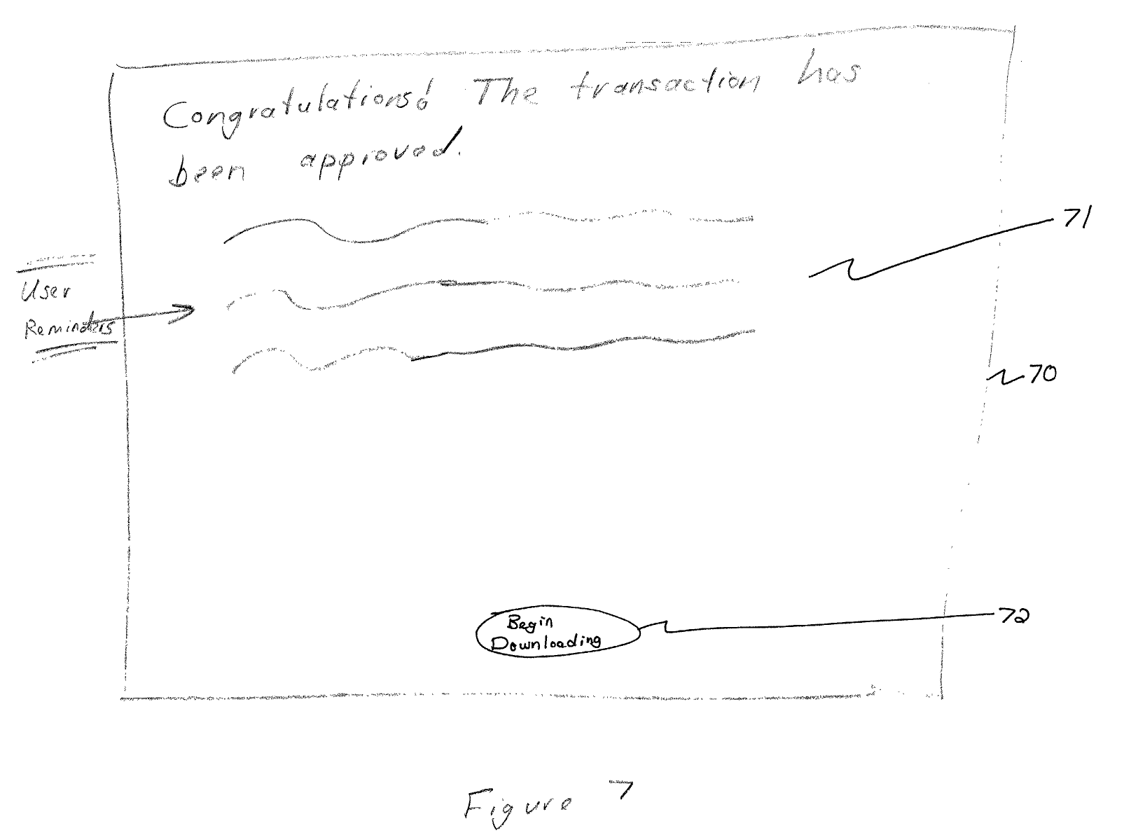

Following approval of the credit card information submitted using page 60, web page 70 (FIG. 7) is next presented to the user. Page 70 presents reminders 71 to the user which notify the user to:

1) check the user's modem connection;

2) make sure VHS or DVD is loaded; and

3) make sure that there is paper in their printer provided they have one.

Once the user has completed checking his/her systems and is ready, the user can begin the down loading process by “clicking” button 72. If a situation occurs such as the VHS tape or DVD runs out during down loading, the system will stop down loading and a warning beep should come on notifying the user that the tape or DVD should be changed. Once everything is back in place, the user will hit “continue” (not shown), and the system will continue its down loading.

As mentioned above, in a particularly preferred embodiment, the zip code associated with a geographic location of the user (input using, for example, page 60 or when the user first logs onto the home repair web site), is used to present the user (via a further web page or a printout such as that shown in FIG. 8) with a list of suppliers in the geographic location of the user that can supply the user with each of the items on the list of materials required to complete the selected home repair topic. The list of suppliers is retrieved from a database associated with the home repair web site based on the user's zip code information, and may be presented either before or after the full-length video is downloaded to the user's computer.

In accordance with a still further aspect, the zip code associated with a geographic location of the user (input using, for example page 60 or when the user first logs onto the home repair web site), is used to present the user (via a further web page or a printout such as that shown in FIG. 9) with a list of contractors in the geographic location of the home owner that can complete a home repair project associated with the home repair topic selected by the user. The list of contractors is retrieved from the database associated with the home repair web site based on the user's zip code information, and may be presented either before or after the full-length video is downloaded to the home user's computer.

In order to defray production costs associated with the various videos and/or create additional revenue for the home repair web site, the distributors and contractors listed on the printouts (see FIG. 8 and 9) may be required to pay a fee for the right to be listed on such printouts. For example, each distributor or contractor may be required to pay an upfront fee to the web site for the right to be included in the database described above, and then a further fee each time the name of the distributor/contractor is presented to a user. In this model, a distributor/contractor may also be given an opportunity to pay an increased fee amount in order to secure the right to be the exclusive distributor/contractor for a given material/subject listed by the web site in a given geographic area.

Alternatively, in order to defray production costs associated with the various videos and/or create additional revenue for the home repair web site, a list of credits would be displayed at the end of each downloaded video or DVD. The credits would list nationwide suppliers, local distributors, and even local contractors that specialize in the type of field associated with the particular video or DVD. Any party wishing to have their name appear as a credit would be required to pay a fee to the web site.

The principles of the present invention may be readily extended to other repair areas beyond home repairs such as, for example, auto repairs. Such a system would allow an individual the opportunity and confidence to repair or adjust their car, and could supply know how from changing oil to dropping in a new engine. In such a system, once the user logged in, a web page would appear with menu/categories displayed leading to other pages. As with the home repair system discussed above, such pages would be used to allow the user to drill down to the specific area of repair for which they need information and assistance. If the user knows what or where their problem is stemming from, a short 30 second or 60 second video clip would appear followed by a few questions and answers that will assist the program in isolating their particular problem. The remaining portions of the system would be analogous to the home repair system described above.

In addition, the principles of the present invention may be extended to non-repair fields, such as the delivery of recipe information for completing cooking procedures. Such a system would allow an individual who is scared by or feels they can't cook, the confidence to go into their kitchen and create a meal whether it's a party of 10 people or a single man or woman who normally would not cook for themselves, by logging onto a web site with a wide range of topics or categories from appetizers to dinners to desserts. Once logged on, a web page would appear with menu/categories displayed leading to other pages. As with the home repair system discussed above, such pages would be used to allow the user to drill down to the specific food or recipe for which they need information and assistance. After identifying the food or recipe of interest, a short 30 second to 60 second process would begin. The remaining portions of the system would be substantially analogous to the home repair system described above.

The previous description of the preferred embodiments is provided to enable any person skilled in the art to make and use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

What is claimed is:

1. A method for delivering home repair information to a home owner over a global computer network, comprising the steps of:
(A) presenting the home owner with a first Internet web page that contains a first list of home repair topics;
(B) presenting the home owner, in response to selection by the home owner of a selected home repair topic from the first internet web page, with at least one second internet web page that contains a second list of home repair topics, wherein the second set of home repair topics correspond to specific home repair topics associated with the home repair topic selected from the first web page; and
(C) downloading a video segment to a computer associated with the home owner in response to selection by the home owner of a home repair topic from the second internet web page.

2. The method of claim 1, wherein step (C) comprises the steps of:
(i) providing a preview video segment to a computer associated with the home owner in response to selection by the home owner of a home repair topic from the second internet web page; and
(ii) after the home owner views the preview video segment, downloading a full-length video segment to a computer associated with the home owner if the home owner approves of such downloading after viewing of the preview, wherein the full-length video segment corresponds to the home repair topic selected from the second internet web page.

3. The method of claim 2, wherein step (C) further comprises presenting the home owner with a third internet web page that contains a list of materials required to complete the home repair topic selected from the second internet web page.

4. The method of claim 3, wherein the list of materials includes a quantity and a price associated with each item on the list of materials.

5. The method of claim 4, wherein, prior to step (C), the home owner is prompted to enter a zip code associated with a geographic location of the home owner, said method further comprising:
(D) retrieving from a database, in response to the zip code and the home repair topic selected from the second internet web page, a list of suppliers in the geographic location of the home owner that can supply the home owner with each of the items on the list of materials required to complete the home repair topic selected from the second internet web page.

6. The method of claim 5, further comprising:
(E) retrieving from a database, in response to the zip code and the home repair topic selected from the second internet web page, a list of contractors in the geographic location of the home owner that can complete a home repair project associated with the home repair topic selected from the second internet web page.

7. A method for delivering auto repair information to a user over a global computer network, comprising the steps of:
(A) presenting the user with a first internet web page that contains a first list of auto repair topics;
(B) presenting the user, in response to selection by the user of a selected auto repair topic from the first internet web page, with at least one second internet web page that contains a second list of auto repair topics, wherein the second set of auto repair topics correspond to specific auto repair topics associated with the auto repair topic selected from the first web page; and
(C) downloading a video segment to a computer associated with the user in response to selection by the user of an auto repair topic from the second internet web page.

8. The method of claim 7, wherein step (C) comprises the steps of:
(i) providing a preview video segment to a computer associated with the user in response to selection by the user of a home repair topic from the second internet web page; and
(ii) after the user views the preview video segment, downloading a full-length video segment to a computer associated with the user if the user approves of such downloading after viewing of the preview, wherein the full-length video segment corresponds to the auto repair topic selected from the second internet web page.

9. The method of claim 8, wherein step (C) further comprises presenting the user with a third internet web page that contains a list of materials required to complete the auto repair topic selected from the second internet web page.

10. The method of claim 9, wherein the list of materials includes a quantity and a price associated with each item on the list of materials.

11. The method of claim 10, wherein, prior to step (C), the user is prompted to enter a zip code associated with a geographic location of the user, said method further comprising:
(D) retrieving from a database, in response to the zip code and the auto repair topic selected from the second internet web page, a list of suppliers in the geographic location of the home owner that can supply the user with each of the items on the list of materials required to complete the auto repair topic selected from the second internet web page.

12. The method of claim 11, further comprising:
(E) retrieving from a database, in response to the zip code and the auto repair topic selected from the second internet web page, a list of contractors in the geographic location of the home owner that can complete a auto repair project associated with the auto repair topic selected from the second internet web page.

13. A method for delivering cooking repair information to a user over a global computer network, comprising the steps of:
(A) presenting the user with a first internet web page that contains a first list of cooking topics;
(B) presenting the user, in response to selection by the user of a selected cooking topic from the first internet web page, with a second internet web page that contains a second list of cooking topics, wherein the second set of cooking topics correspond to specific cooking topics associated with the cooking topic selected from the first web page; and
(C) downloading a video segment to a computer associated with the user in response to selection by the user of a cooking topic from the second internet web page.
